(19) United States
(12) Patent Application Publication
(10) Pub. No.: US 2008/0263657 A1
(43) Pub. Date: Oct. 23, 2008

(54) Control of Media Components in a Session

(76) Inventor: Tuija Hurtta, Espoo (FI)

Correspondence Address: MORGAN & FINNEGAN, L.L.P., 3 WORLD FINANCIAL CENTER, NEW YORK, NY, 10281-2101, US

(21) Appl. No.: 11/596,144

(22) PCT Filed: May 10, 2005
(86) PCT No.: PCT/IB2005/001829

§ 371 Date: Feb. 27, 2008

(30) Foreign Application Priority Data
May 12, 2004 (GB) 0410624.1

(51) Int. Cl. G06F 21/00

(52) U.S. Cl. 726/21

(57) ABSTRACT

A method for applying control to a plurality of media components in a media session, comprising determining a level of control for at least one component, and applying the determined level of control to said at least one component.

### BACKGROUND OF THE INVENTION

1. Field of the Invention

The invention relates to the control or authorisation of an Internet protocol multimedia subsystem, IMS. Particularly, but not exclusively, the invention relates to the control of quality of service of media components within a media session.

2. Description of the Related Art

So-called third generation (3G) mobile communication networks are currently being deployed. In Europe such networks conform to various standards formalized by the 3^{rd} Generation Partnership Project (3GPP), which has a number of versions, generally known as releases.

3G mobile communications systems support an Internet protocol multimedia subsystem (IMS). An IMS supports multimedia sessions. Generally many different types of media component may be established within a multimedia session. For example, a voice media component and a messaging media component may be established in a media session.

Some media components require the application of authorization or control, such as quality of service control. For example a voice media component preferably requires quality of service control, whilst a messaging media component does not.

In current proposals for IMS sessions, it is proposed that if a single media component within a media session requires quality of service control, then that quality of service control is applied to all media components within the media session.

### SUMMARY OF INVENTION

It is an aim of the invention to provide an improved Internet protocol multimedia subsystem.

In a first aspect, the invention provides a method of controlling an Internet protocol multimedia subsystem, IMS, comprising allocating an authorisation token to an individual media component. The allocating step may be a selectively allocating step. The method may comprise selectively allocating authorisation tokens to a plurality of media components. Preferably the step of selectively allocating authorisation tokens comprises allocating authorisation tokens to those media components for which authorisation or control is required.

The control is preferably quality of service, QoS, control. For QoS control purposes, the method may further comprise the step of transmitting application session information from the application function, AF, to a policy decision function, PDF, of those media components for which authorisation/control is required. An application function may be a proxy call state control function, P-CSCF, of the IMS.

At bearer establishment or modification, the method may further comprise the step of transmitting an authorisation token from a user equipment, UE, to those media components for which authorisation/control is required.

In accordance with the first aspect of the invention, there is preferably provided an application function adapted in accordance with the method. Also in accordance with the first aspect of the invention, there is preferably provided a user equipment adapted in accordance with the method. Preferably, the adapted application function or the adapted user equipment is deployed in an IMS. An IMS may include, or be connected to, a thus adapted application function or user equipment.

In a second aspect, the invention provides a method of controlling an Internet protocol multimedia subsystem, IMS, comprising allocating an authorisation token to each application session. The session may be an IMS session.

The method may include a step of requiring authorisation or control, and responsive to said step the method may further comprise the step of allocating a new attribute to an individual media component. The new attribute may be an attribute indicating that authorisation or control is required. The new attribute may be an attribute indicating that authorisation or control is not required. The control is preferably quality of service, QoS, control. For QoS control purposes, the method may further comprise the step of transmitting application session information from the application function, AF, to a policy decision function, PDF, of those media components for which authorisation/control is required. An application function may be a proxy call state control function, P-CSCF, of the IMS.

At bearer establishment or modification, the method may further comprise the step of transmitting an authorisation token from a user equipment, UE, to those media components for which authorisation/control is required.

In accordance with the second aspect of the invention, there is preferably provided an application function adapted in accordance with the method. Also in accordance with the second aspect of the invention, there is preferably provided a user equipment adapted in accordance with the method. Preferably, the adapted application function or the adapted user equipment is deployed in an IMS. An IMS may include, or be connected to, a thus adapted application function or user equipment.

In a third aspect, the invention provides a method of controlling an Internet protocol multimedia subsystem, IMS, comprising allocating an authorisation token to an individual application session. The allocation may be selective. The session may be an IMS session.

For QoS control purposes, the method may further comprise the step of transmitting application session information from an application function, AF, to a policy decision function, PDF, of those media components for which authorisation/control is required. An application function may be a proxy call state control function, P-CSCF, of the IMS.

At bearer establishment, or bearer modification, the method may include the step of the gateway GPRS support node, GGSN, receiving the authorisation token. The method may further include, responsive to receipt of the authorisation token at the GGSN the step of determining whether authorisation or control for the bearer should take place. The method preferably further includes the step of receiving, at the GGSN, an authorisation token for each bearer which will carry the media components of the IMS session. The method may further comprise the step of determining the requirement for authorisation or control.

The step of determining the requirement for authorisation or control may be dependent on, for example, the traffic class of the bearer. The traffic class of the bearer may be, for example, conversational or streaming, in which cases authorisation or control may be required, or interactive or background, in which case authorisation or control may not be required.

Responsive to the GGSN determining that authorisation or control is not required, the method further comprises the step of the GGSN applying a local policy for the bearer. The GGSN preferably does not contact the PDF. The GGSN is thus allowed to accept the bearer without PDF involvement.

In a fourth aspect, the invention provides a method of controlling an Internet protocol multimedia subsystem, IMS, comprising determining whether a plurality of media components are required to be authorised of controlled, wherein responsive to a determination of at least one media component to be authorised or controlled and at least one media component not to be authorised or controlled, the method further comprises the step of not allocating—or inhibiting—an authorisation token.

The control is preferably quality of service, QoS, control. For QoS control purposes, the method may further comprise the step of transmitting application session information from the application function, AF, to a policy decision function, PDF, of those media components for which authorisation or control is required. An application function may be a proxy call state control function, P-CSCF, of the IMS.

At bearer establishment or modification, preferably the GGSN does not receive an authorisation token. The GGSN is preferably adapted to determine a PDF address independent of an authorisation token. The GGSN may, for example, store a pre-configured PDF address for each access point. The GGSN is preferably adapted to use binding information independent of an authorisation token. The binding information may, for example, be a service flow classifier. The method may include the step of identifying a service flow, and further include the step of transmitting an authorization or control request from the GGSN to a PDF responsive to identification of a service flow.

The method may include the step of receiving a pushed decision from the PDF at the GGSN, the pushed decision being generated by the PDF when it knows the media components to be authorised or controlled, the method further comprising transmitting an authorisation or control request from the GGSN to the PDF responsive to the establishment of the bearer.

In a fifth aspect, the invention provides a method of controlling an Internet protocol multimedia subsystem, IMS, comprising allocating an authorisation token to an individual application session. The session may be an IMS session. The allocating step may be a step of selectively allocating.

The control is preferably quality of service, QoS, control. For QoS control purposes, the method may further comprise the step of transmitting application session information from the application function, AF, to a PDF of those media components for which authorisation or control is required. An application function may be a proxy call state control function, P-CSCF, of the IMS. The method may further comprise the step of transmitting application session information from the Application Function, AF, to the PDF on the media components which are not supposed to authorised or controlled.

At bearer establishment or modification, the method may further comprise the step of receiving an authorisation token at the GGSN. The method may further compromise the step of, at the GGSN, determining whether authorisation or control for the bearer should take place. In this respect, the method preferably includes the step of receiving, at the GGSN, an authorisation token for each bearer which will carry media components of the IMS session.

The PDF may inform the GGSN on the media components which are not supposed to be authorised or controlled. This may occur when the GGSN requests authorisation or control for a bearer. The method may also include the step of the PDF pushing information as an unsolicited authorisation or control decision to the GGSN.

The invention provides, in one aspect, a method of applying control to a plurality of media components in a media session, comprising determining a level of control for at least one component, and applying the determined level of control to said at least one component. The control may be quality of service control.

The step of determining a level of control for at least one media component may include determining that at least one component does not require control, wherein the step of applying the determined level of control comprises applying no control for said at least one media component.

The method may further comprise the step of, for each media component having a determined level of control, allocating an authorisation token for that media component.

The method may further comprise the step of allocating an authorisation token for the media session.

The method may further comprise the step of, for each media component having a determined level of control corresponding to the authorisation token of the media session, allocating an attribute to that media component. The attribute may indicate that the authorisation token of the media session is to be applied for that media component.

The method may further comprise the step of, for each media component not having a determined level of control corresponding to the authorisation token of the media session, allocating an attribute to that media component.

The attribute may indicate that the authorisation token of the media session is not to be applied for that media component.

The invention provides, in one other aspect, an IP multimedia subsystem including means for of applying control to a plurality of media components in a media session, the means being adapted to include determining means for determining a level of control for at least one component, and applying means for applying the determined level of control to said at least one component. The control may be quality of service control.

The determining means may be adapted to determine that at least one component does not require control, wherein the applying means is adapted to apply no control for said at least one media component.

The IP multimedia subsystem may further comprise, for each media component having a determined level of control, allocating means for allocating an authorisation token for that media component.

The IP multimedia subsystem may further comprise allocating means for allocating an authorisation token for the media session.

For each media component having a determined level of control corresponding to the authorisation token of the media session, there may be provided means for allocating an attribute to that media component.

The attribute may indicate that the authorisation token of the media session is to be applied for that media component.

For each media component not having a determined level of control corresponding to the authorisation token of the media session, an allocation means may be adapted to allocate an attribute to that media component.

The attribute may indicate that the authorisation token of the media session is not to be applied for that media component.

### BRIEF DESCRIPTION OF THE FIGURES

The invention will now be described by way of reference to the accompanying drawings, in which:

FIG. 1 illustrates the components of an example IP multimedia subsystem; and

FIGS. 2(a) to 2(d) illustrate the principles of applying authorisation or control requirements in embodiments of the invention.

### DESCRIPTION OF THE PREFERRED EMBODIMENTS

The invention is described herein by way reference to a number of illustrative embodiments, all of which described different embodiments of the general inventive principles. The invention is not limited to any specific aspect of any one embodiment.

In an IP (Internet protocol) multimedia subsystem (IMS) sessions are established for communications. In a session, there is typically a plurality of media components. Some of these components may require quality of service mechanisms to be applied, and some of these components may require quality of service mechanisms not to be applied. For example, a voice media component may require quality of service mechanisms to be applied, whilst a messaging media component may not require quality of service to be applied. The invention and embodiments thereof allow for different control or authorisation mechanisms to be applied to different media components within a media session.

Certain embodiments of the invention will be described in the following by way of example, with reference to the exemplifying architecture of a third generation (3G) mobile communications system. However, it shall be appreciated that the embodiments may be applied to any suitable communication system.

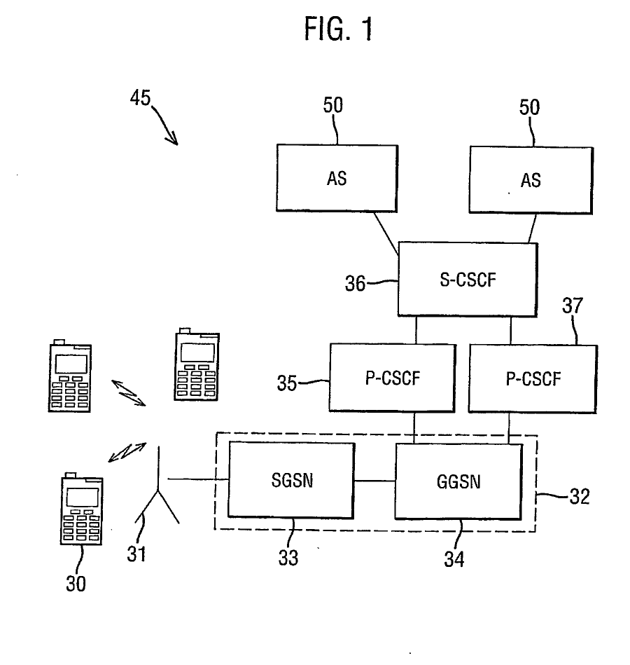

Reference is made to FIG. 1 which shows an example of a network architecture in which the invention may be embodied. In FIG. 1 an IP Multimedia Subsystem 45 is provided for offering IP multimedia services for IP Multimedia Subsystem subscribers.

Access to IP Multimedia (IM) services can be provided by means of a mobile communication system. A mobile communication system is typically arranged to serve a plurality of mobile user equipment usually via a wireless interface between the user equipment and at least one base station 31 of the communication system. The mobile communication system may logically be divided between a radio access network (RAN) and a core network (CN).

The base station 31 is arranged to transmit signals to and receive signals from a mobile user equipment 30 via a wireless interface between the user equipment and the radio access network. Correspondingly, the mobile user equipment 30 is able to transmit signals to and receive signals from the radio access network via the wireless interface.

In the shown arrangement the user equipment 30 may access the IMS network 45 via the access network associated with the base station 31. It shall be appreciated that, although, for clarity reasons FIG. 1 shows a base station of only one radio access network, a typical communication network system usually includes a number of radio access networks.

The 3G radio access network (RAN) is typically controlled by an appropriate radio network controller (RNC). This controller is not shown in order to enhance clarity. A controller may be assigned for each base station or a controller can control a plurality of base stations, for example in the radio access network level. It shall be appreciated that the name, location and number of the radio network controllers depends on the system.

The mobile user equipment 30 of FIG. 1 may comprise any appropriate mobile user equipment adapted for Internet Protocol (IP) communication to connect to the network. For example, the mobile user may access the cellular network by means of a Personal computer (PC), Personal Data Assistant (PDA), mobile station (Ms) and so on. The following examples are described with reference to mobile stations.

It shall be appreciated that although only a few mobile stations are shown in FIG. 1 for clarity, a great number of mobile stations may be in simultaneous communication with a communication system.

A core network (CN) typically includes various switching and other control entities and gateways for enabling the communication via a number of radio access networks and also for interfacing a single communication system with one or more communication systems such as with other cellular systems and/or fixed line communication systems. In 3GPP systems the radio access network is typically connected to an appropriate core network entity or entities such as, but not limited to, a serving general packet radio service (GPRS) support node (SGSN) 33. The radio access network is in communication with the serving GPRS support node via an appropriate interface, for example on an Iᵤ interface. The serving GPRS support node, in turn, typically communicates with an appropriate gateway, for example a gateway GPRS support node 34 via the GPRS backbone network 32. This interface is commonly a switched packet data interface.

In a 3GPP network, a packet data session is established to carry traffic flows over the network. Such a packet data session is often referred to as a packet data protocol (PDP) context. A PDP context may include a radio bearer provided between the user equipment and the radio network controller, a radio access bearer provided between the user equipment, the radio network controller and the SGSN 33, and switched packet data channels provided between the serving GPRS service node 33 and the gateway GPRS service node 34. Each PDP context usually provides a communication pathway between a particular user equipment and the gateway GPRS support node and, once established, can typically carry multiple flows. Each flow normally represents, for example, a particular service and/or a media component of a particular service. The PDP context therefore often represents a logical communication pathway for one or more flows across the network. To implement the PDP context between user equipment and the serving GPRS support node, at least one radio access bearer (RAB) needs to be established which commonly allows for data transfer for the user equipment. The implementation of these logical and physical channels is known to those skilled in the art and is therefore not discussed further herein.

FIG. 1 shows also a plurality of application servers 50 connected to the exemplifying Internet Protocol (IP) Multimedia network 45. The user equipment 30 may connect, via the GPRS network 32 and an IMS network 45, to at least one of the application servers 50. It shall be appreciated that a greater number of application servers may be connected to a data network.

Communication with the application servers is controlled by means of functions of the data network that are provided by appropriate controller entities. For example, in the current third generation (3G) wireless multimedia network architectures it is assumed that several different servers providing various control functions are used for the control. These include functions such as the call session or call state control functions (CSCFs). The call session functions may be divided into various categories. FIG. 1 shows proxy call session control functions (P-CSCF) 35 and 37 and a serving call session control function (S-CSCF) 36. It shall be appreciated that similar functions may be referred to in different systems with different names.

A user who wishes to use services, or application functions, provided by an application server via the IMS system may need first to register with a serving controller, such as the serving call session control function (S-CSCF) 36. The registration is required to enable the user equipment to request a service from the multimedia system. As shown in FIG. 1, communication between the S-CSCF 36 and the user equipment 30 may be routed via at least one proxy call session control function (P-CSCF) 35. The proxy CSCF 35 thus acts as a proxy which forwards messages from the GGSN 34 to a serving call session control function 36 and vice versa.

The invention is now described in further detail hereinafter by way of description of five embodiments.

In the first embodiment an authorisation token, which indicates the quality of service or other control to be applied to a media component, is allocated per media component. However, the authorisation token is preferably allocated only to those media components for which authorisation/control is to take place.

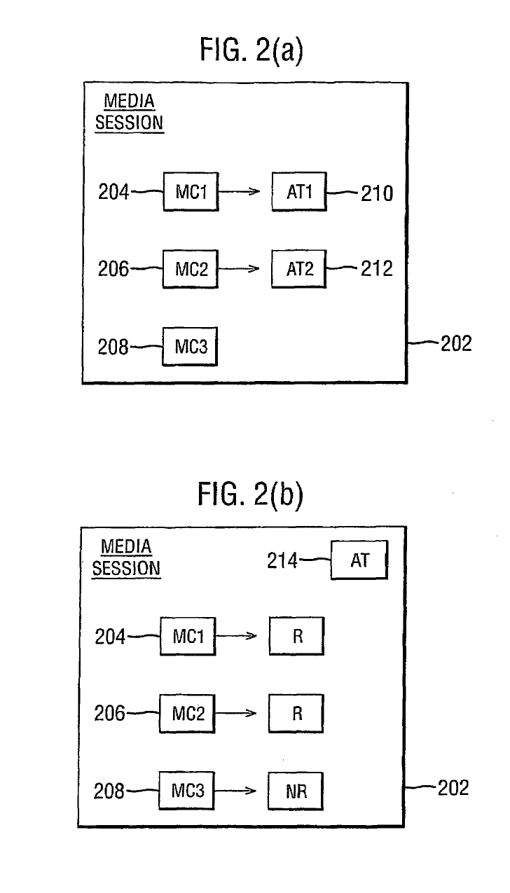

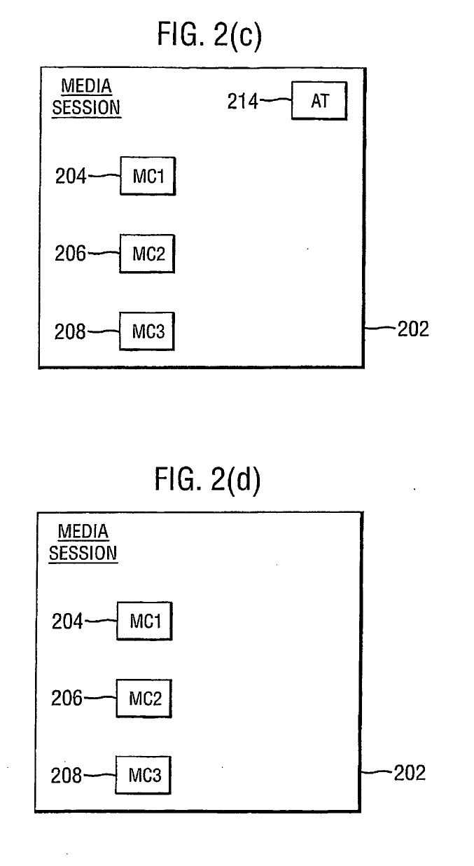

This is further illustrated in FIG. 2. FIGS. 2(a) to 2(d) represent the allocation of authorisation tokens in different embodiments of the invention. The allocation illustrated in FIG. 2(a) is relevant to this first embodiment. Referring to FIG. 2(a), there is generally illustrated by reference numeral 202 a media session. For the purposes of example, the media session 202 is assumed to comprise three media components MC1, MC2, MC3 denoted by reference numerals 204, 206, 208 respectively. The number of media components associated with any given media session will vary between implementations.

For the purposes of this example, it is assumed that the media components MC1 204 and MC2 206 require authorisation/control, and media component MC3 208 does not require authorisation/control.

Referring further to FIG. 2(a), it can be thus seen that, in accordance with the first embodiment of the invention, the media component MC1 204 is associated with an authorisation token AT1 denoted by reference numeral 210, and the media component MC2 206 is associated with an authorisation token AT2 denoted by reference numeral 212 The media component MC3 208 is not associated with any authorisation token.

In the preferred embodiment, the control/authorisation is quality of service (QoS) control. For quality of service control purposes, an application function, for example a P-CSCF 35 of the IMS 45, sends application session information to the policy decision function (PDF) only on the media components whish are to be authorised/controlled.

Thus, referring again to FIG. 2(a), in the described embodiment the application function sends application session information to the packet data flow on the media components MC1 204 and MC2 206, but not MC3 208.

At bearer establishment or bearer modification, the user equipment 30 sends an authorisation token only for the media components to be authorised or controlled, i.e. for the media components MC1 204 and MC2 206.

This technique, in accordance with the first embodiment of the invention, requires the application function and the user equipment to be modified, to allow the transmission of the information as described. Thus the various means of the application function and/or the user equipment may be adapted to perform the described operations.

In the second embodiment, an authorisation token is allocated per application session, for example per IMS session.

A new attribute for authorisation or control requirement is allocated for each media component. The attribute may be, for example, authorisation/control required/authorisation/control not required.

This is further illustrated in FIG. 2(b). Referring to FIG. 2(b), there is again generally illustrated by reference numeral 202 a media session, which again for the purposes of example generally comprises three media components MC1, MC2, MC3 denoted by reference numerals 204, 206, 208 respectively.

For the purposes of this example, it is again assumed that the media components MC1 204 and MC2 206 require authorisation/control, and media component MC3 208 does not require authorisation/control.

Referring further to FIG. 2(b), it can be thus seen that, in accordance with the second embodiment of the invention, the media session 202 is allocated an authentication token AT denoted by reference numeral 214.

The media component MC1 204 is then associated with a ‘required’ attribute R denoted by reference numeral 216, which generally indicates that use of the media session authentication token is necessary for that media component. Similarly the media component MC2 206 is associated with a ‘required’ attribute R denoted by reference numeral 218. The media component MC3 208 is conversely associated with a ‘not required’ attribute NR denoted by reference numeral 220, indicating that it is not associated with the media session authorisation token.

Once again, for quality of service control purposes, the application function preferably sends application session information to the policy decision function only on the media components to be authorised or controlled.

At bearer establishment or bearer modification, the user equipment 30 sends an authorisation token only for the media components to be authorised or controlled, i.e. for the media components MC1 204 and MC2 206.

This technique, in accordance with the second embodiment of the invention, requires the application function and the user equipment to be modified, to allow the transmission of the information as described. Thus the various means of the application function and/or the user equipment may be adapted to perform the described operations.

In the third embodiment, as in the second embodiment, an authorisation token is allocated for each application session, for example for each IMS session.

Referring further to FIG. 2(c), it can be thus seen that, in accordance with the third embodiment of the invention, the media session 202 is allocated an authentication token AT denoted by reference numeral 214. However the media components are not provided with attributes as in the second embodiment.

For quality of service control purposes, the application function, such as the P-CSCF 35 of the IMS 45, sends application session information to the policy decision function only on the media components to be authorised or controlled.

The GGSN 34 receives an authorisation token for bearer establishment or bearer modification and determines whether authorisation or control for the bearer should take place. The GGSN preferably receives the authorisation token for each bearer which will carry the media components of the IMS session.

The GGSN 34 may determine the requirement for authorisation or control, for example, based on the traffic class of the bearer. The traffic class of the data bearer may be, for example, conversational or streaming, in which cases authorisation or control may be required, or interactive or background, in which cases authorisation or control may not be required.

If the GGSN 34 determines that authorisation or control is not required, the GGSN does not contact the policy decision function, but applies local policy for the bearer. That is, the GGSN is allowed to accept the bearer without policy decision function involvement.

In the fourth embodiment, no authorisation token is allocated for an application session which contains both media components to be authorised or controlled and media components not to be authorised or controlled.

Referring further to FIG. 2(d), it can be thus seen that, in accordance with the fourth embodiment of the invention, the media session 202 is not allocated an authentication token and the media components MC1 204, MC2 206, MC3 208 are not allocated individual authentication tokens.

For quality of service control purposes, again, the application function, for example the P-CSCF 35 of the IMS, sends application session information to the packet data flow only on the media components to be authorised or controlled.

The GGSN 34 does not receive authorisation tokens at bearer establishment or bearer modification. The GGSN 34 has other means than the authorisation token to determine the packet data flow address. This other means may, for example, be a pre-configured policy decision function address per access point.

The GGSN 34 may use information other than the authorisation token as binding information (e.g. a service flow classifier). In this alternative, the GGSN 34 sends an authorisation or control request to the policy decision function when a service flow is identified.

Alternatively, it is also possible that the GGSN 34 may send an authorisation or control request to the policy decision function when the bearer is established, and the policy decision function pushes a new decision when it knows the media components to be authorised or controlled.

In the fifth embodiment an authorisation token is allocated for each application session, for example each IMS session.

Referring further to FIG. 2, the illustration of FIG. 2(c), described hereinabove with reference to the third embodiment, applies also to the fifth embodiment.

For quality of service control purposes, the application function, for example the P-CSCF 35 of the IMS 45, sends application session information to the policy fecision function on the media components to be authorised or controlled. In addition, the application function sends application session information to the policy decision function on the media components which are not supposed to be authorised or controlled.

The GGSN 34 receives the authorisation token at bearer establishment or bearer modification and determines whether authorisation or control for the bearer should take place. The GGSN 34 preferably receives the authorisation token for each bearer which will carry the media components of the IMS session. The policy decision function informs the GGSN 34 on the media components which are not supposed to be authorised or controlled. This may happen when the GGSN 34 requests authorisation or control for a bearer. Alternatively, the packet data flow may push this information as an unsolicited authorisation/control decision to the GGSN 34.

The invention has been described in relation to five preferred embodiments. The invention is not limited to any specific aspect of the described embodiments. In general, the invention provides for flexible control or authorisation of IMS sessions. This is generally achieved by allowing different media components within a media session to have different defined control or authentication information.

Certain embodiments provide a technique in which an authentication token allocated to an IMS session is selectively applied to the media components within the session.

Modifications to the various embodiments described herein will be apparent to one skilled in the art. Various ones of the embodiments may also be combined. The scope of protection afforded by the invention is defined by the appended claims.

1. A method of applying control to a plurality of media components in a media session, comprising determining a level of control for at least one component, and applying the determined level of control to said at least one component.

2. A method according to claim 1 wherein the control is quality of service control.

3. A method according to claim 1 wherein determining a level of control for at least one media component includes determining that at least one component does not require control, wherein applying the determined level of control comprises applying no control for said at least one media component.

4. A method according to claim 1 further comprising, for each media component having a determined level of control, allocating an authorization token for that media component.

5. A method according to claim 1 further comprising allocating an authorization token for the media session.

6. A method according to claim 5 further comprising, for each media component having a determined level of control corresponding to the authorization token of the media session, allocating an attribute to that media component.

7. A method according to claim 6 wherein the attribute indicates that the authorization token of the media session is to be applied for that media component.

8. A method according to claim 5 further comprising, for each media component not having a determined level of control corresponding to the authorization token of the media session, allocating an attribute to that media component.

9. A method according to claim 8 wherein the attribute indicates that the authorization token of the media session is not to be applied for that media component.

10. An IP multimedia subsystem including means for applying control to a plurality of media components in a media session, the means for applying control comprising: determining means for determining a level of control for at least one component, and applying means for applying the determined level of control to said at least one component.

11. An IP multimedia subsystem according to claim 10 wherein the control is quality of service control.

12. An IP multimedia subsystem according to claim 10 wherein the determining means is adapted to determine that at least one component does not require control, wherein the applying means is adapted to apply no control for said at least one media component.

13. An IP multimedia subsystem according to claim 10 further comprising, for each media component having a determined level of control, allocating means for allocating an authorization token for that media component.

14. An IP multimedia subsystem according to claim 10 further comprising allocating means for allocating an authorization token for the media session.

15. An IP multimedia subsystem according to claim 14 wherein, for each media component having a determined level of control corresponding to the authorization token of the media session, there is provided means for allocating an attribute to that media component.

16. An IP multimedia subsystem according to claim 15 wherein the attribute indicates that the authorization token of the media session is to be applied for that media component.

17. An IP multimedia subsystem according to claim 14 wherein, for each media component not having a determined level of control corresponding to the authorization token of the media session, an allocation means is adapted to allocate an attribute to that media component.

18. An IP multimedia subsystem according to claim 17 wherein the attribute indicates that the authorization token of the media session is not to be applied for that media component.
